(19) United States
(12) Patent Application Publication
(10) Pub. No.: US 2015/0228123 A1
(43) Pub. Date: Aug. 13, 2015

(54) Hybrid Method to Identify AR Target Images in Augmented Reality Applications

(71) Applicant: daTangle, Inc., San Jose, CA (US)

(72) Inventor: Taizo Yasutake, Cupertino, CA (US)

(73) Assignee: daTangle, Inc., San Jose, CA (US)

(21) Appl. No.: 14/615,582

(22) Filed: Feb. 6, 2015

Related U.S. Application Data
(60) Provisional application No. 61/965,753, filed on Feb. 7, 2014.

(51) Int. Cl. G06T 19/00; G06T 11/60

(52) U.S. Cl. CPC G06T 19/006; G06T 11/60

(57) ABSTRACT

A method for detecting an augmented reality (AR) target image and retrieving AR content for the detected AR image is disclosed. The method is performed at a computer system having one or more processors and memory for storing programs to be executed by the one or more processors. The method includes receiving data of the AR target image. The method includes detecting, based on the data of the AR target image, a group of markers on the AR target image. The method includes calculating a set of cross ratios based on the group of markers. The method also includes retrieving, based on the set of cross ratios, AR content associated with the AR target image. The method further includes displaying the retrieved AR content and the AR target image in a single AR scene.

### PRIORITY CLAIM AND RELATED APPLICATION

This application claims priority to U.S. Provisional Application No. 61/965,753, entitled “A Hybrid Method to Identify AR Target Images in Augmented Reality Applications,” filed Feb. 7, 2014.

### FIELD OF THE APPLICATION

The present application generally relates to the field of computer technologies, and more particularly to a method and apparatus for identifying and displaying augmented reality (AR) content.

### BACKGROUND

Nowadays, some known AR applications can be used to detect an AR target image and display AR content together with the AR target in an AR scene. Such known AR applications typically adopt a marker-based method or a markerless method for image processing. Specifically, a marker-based AR application can detect marker(s) in the AR target image and then retrieve AR context based on the detected marker(s). Design of the markers, however, typically provides a non-esthetic visual look when the markers are applied to commercial products. On the other hand, a markerless AR application can detect visually distinctive features distributed in the AR target image as key points, and then compare the acquired key points with reference key point data stored at an AR database. AR content corresponding to the key points that match the acquired key points can then be retrieved and displayed. Such a markerless AR application, however, typically requires high CPU burden due to complex computing and processing of data, particularly for continuous visual search of the AR database. Furthermore, the markerless AR applications typically show unreliable detection performance when the target image contains repetitive patterns or other less-distinctive features.

Therefore, a need exists for a method and apparatus that can provide a fast and reliable AR content search, as well as an esthetic visual look for an AR target image.

### SUMMARY

The above deficiencies associated with the known AR applications may be addressed by the techniques described herein.

In some embodiments, a method for detecting an AR target image and retrieving AR content for the detected AR target image is disclosed. The method is performed at a user device, which has one or more processors and memory for storing one or more programs to be executed by the one or more processors. The method includes receiving data of the AR target image. The method includes detecting, based on the data of the AR target image, a group of markers on the AR target image. In some instances, the group of markers can include at least five dots. In some instances, the group of markers can be located within a first region of the AR target image, and an image can be displayed within a second region of the AR target image that is mutually exclusive from the first region of the AR target image.

The method includes calculating a set of cross ratios based on locations of the group of markers. In some instances, the set of cross ratios can include at least two cross ratios. In some instances, the method includes calculating the set of cross ratios based on a set of projected coordinates of the group of markers and a unique order of the group of markers. The set of projected coordinates and the unique order of the group of markers can be determined based on the data of the AR target image. In some instances, the unique order of the group of markers can be determined based on at least a shape of a marker from the group of markers, a design of a marker from the group of markers, a color of a maker from the group of markers, a predefined rotational direction, and/or the like.

The method also includes retrieving, based on the set of cross ratios, AR content associated with the AR target image. In some instances, the AR content can include a three-dimensional (3D) object. In some instances, retrieving the AR content includes sending the calculated set of cross ratios to a database such that the calculated set of cross ratios is compared with a group of predefined sets of cross ratios stored in the database, and a predefined set of cross ratios that matches the calculated set of cross ratios is determined from the group of predefined sets of cross ratios. AR content associated with the determined predefined set of cross ratios is then retrieved from the database and provided to the user device. The method further includes displaying the retrieved AR content and the AR target image in a single AR scene.

In some embodiments, a user device includes one or more processors and memory storing one or more programs for execution by the one or more processors. The one or more programs include instructions that cause the user device to perform the method for detecting an AR target image and retrieving AR content for the detected AR target image as described above. In some embodiments, a non-transitory computer readable storage medium of a user device stores one or more programs including instructions for execution by one or more processors. The instructions, when executed by the one or more processors, cause the processors to perform the method of detecting an AR target image and retrieving AR content for the detected AR target image as described above.

In some embodiments, a method for searching and retrieving AR content for an AR target image is disclosed. The method is performed at a server device, which has one or more processors and memory for storing programs to be executed by the one or more processors. The method includes receiving a set of cross ratios associated with the AR target image. The method includes comparing the received set of cross ratios with a group of predefined sets of cross ratios. Each predefined set of cross ratios from the group of predefined sets of cross ratios is associated with an AR content file from a group of AR content files. The method also includes determining, based on the comparison result, an AR content file from the group of AR content files. The method further includes sending AR content associated with the AR content file to a user device such that the user device displays the AR content and the AR target image in a single AR scene.

In some instances, the method includes determining, from the group of predefined sets of cross ratios, a predefined set of cross ratios that matches the received set of cross ratios. The method includes identifying, from the group of AR content files, the AR content file associated with the determined predefined set of cross ratios.

In some instances, each predefined set of cross ratios from the group of predefined sets of cross ratios can be associated with data of a keypoint descriptor and an AR content file from a group of AR content files, where the data of the keypoint descriptor is associated with the AR content file. In such instances, the method further includes receiving data of a keypoint descriptor of the AR target image.

Moreover, to determine the AR content file, the method includes identifying, based on the comparison result and from the group of predefined sets of cross ratios, a subset of the group of predefined sets of cross ratios. Each predefined set of cross ratios from the subset of the group of predefined sets of cross ratios is closer to the received set of cross ratios than each predefined set of cross ratios excluded from the subset of the group of predefined sets of cross ratios. The method includes comparing the data of the keypoint descriptor of the AR target image with data of keypoint descriptors associated with the subset of the group of predefined sets of cross ratios. The method also includes determining, based on the comparison of data of keypoint descriptors, data of a keypoint descriptor that matches the data of the keypoint descriptor of the AR target image. The method further includes identifying the AR content file associated with the determined data of keypoint descriptor.

Various advantages of the present application are apparent in light of the descriptions below.

### BRIEF DESCRIPTION OF DRAWINGS

The aforementioned implementation of the present application as well as additional implementations will be more clearly understood as a result of the following detailed description of the various aspects of the application when taken in conjunction with the drawings.

FIG. 1 is a schematic diagram illustrating a system configured to identify an AR target image and display AR content with the AR target image in a single AR scene in accordance with some embodiments.

FIGS. 2A and 2B are schematic illustrations of displaying AR content together with an AR target image in a single AR scene in accordance with some embodiments.

FIG. 3 is a flow chart illustrating a method for retrieving and displaying AR content associated with an AR target image in accordance with some embodiments.

FIG. 3A is a flow chart illustrating a method for performing a step in the method of FIG. 3.

FIGS. 4A-4C are schematic diagrams illustrating layouts of AR target images in accordance with some embodiments.

FIGS. 5A-5L are schematic illustrations of calculating cross ratios based on markers in an AR target image in accordance with some embodiments.

FIG. 6A is a schematic diagram illustrating communications between an AR user device and an AR server device in accordance with some embodiments.

FIG. 6B is a flow chart illustrating a method for searching and retrieving AR content associated with an AR target image in accordance with some embodiments.

FIG. 6C is a flow chart illustrating a method for performing a step in the method of FIG. 6B.

FIG. 7 is a block diagram illustrating components of a user device in accordance with some embodiments.

Like reference numerals refer to corresponding parts throughout the several views of the drawings.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

To promote an understanding of the objectives, technical solutions, and advantages of the present application, embodiments of the present application are further described in detail below with reference to the accompanying drawings.

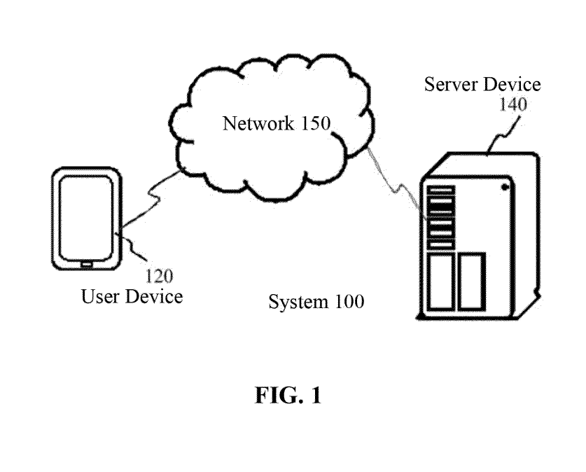

FIG. 1 is a schematic diagram illustrating a system 100 configured to identify an AR target image and display AR content with the AR target image in a single AR scene in accordance with some embodiments. As shown in FIG. 1, the system 100 includes a server device 140 and a user device 120. The server device 140 is operatively coupled to and communicates with the user device 120 via a network 150. Although not shown in FIG. 1, the user device 120 can be accessed and operated by one or more users. The server device 140 and the user device 120 of the system 100 are configured to collectively perform a task of displaying AR content with an AR target image, including identifying the AR target image, determining appropriate AR content for the AR target image, retrieving the appropriate AR content, and displaying the appropriate AR content with the AR target image in a single AR scene.

Although shown in FIG. 1 as including a single server device and a single user device, in other embodiments, a system configured to display AR content can include any number of server devices and/or any number of user devices. Each server device included in such a system can be identical or similar to the server device 140, and each user device included in such a system can be identical or similar to the user device 120. For example, multiple user devices can be operatively coupled to and communicate with a server device such that each user device from the multiple user devices can be operated by a user to display AR content. For another example, a user device can be operatively coupled to and communicate with multiple server devices to receive various AR content from the different server devices.

The network 150 can be any type of network configured to operatively couple one or more server devices (e.g., the server device 140) to one or more user devices (e.g., the user device 120), and enable communications between the server device(s) and the user device(s). In some embodiments, the network 150 can include one or more networks such as, for example, a cellular network, a satellite network, a local area network (LAN), a wide area network (WAN), a wireless local area network (WLAN), etc. In some embodiments, the network 150 can include the Internet. Furthermore, the network 150 can be optionally implemented using any known network protocol including various wired and/or wireless protocols such as, for example, Ethernet, universal serial bus (USB), global system for mobile communications (GSM), enhanced data GSM environment (EDGE), general packet radio service (GPRS), long term evolution (LTE), code division multiple access (CDMA), wideband code division multiple Access (WCDMA), time division multiple access (TDMA), bluetooth, Wi-Fi, voice over internet protocol (VoIP), Wi-MAX, etc.

The server device 140 can be any type of device configured to function as a server-side device of the system 100. Specifically, the server device 140 is configured to communicate with one or more user devices (e.g., the user device 120) via the network 150, and provide AR content to the user device(s). In some embodiments, the server device 140 can be, for example, a background server, a back end server, a database server, a workstation, a desktop computer, a cloud computing server, a data processing server, and/or the like. In some embodiments, the server device 140 can be a server cluster or server center consisting of two or more servers (e.g., a data processing server and a database server). In some embodiments, the server device 140 can be referred to as, for example, an AR server.

In some embodiments, the server device 140 can include a database that is configured to store AR content and other data and/or information associated with AR target images. In some embodiments, a server device (or an AR server, e.g., the server device 140) can be any type of device configured to store AR content and accessible to one or more user devices (or AR devices, e.g., the user device 120). In such embodiments, the server device can be accessed by a user device via one or more wired and/or wireless networks (e.g., the network 150) or locally (i.e., not via a network). In some embodiments, the server device can be accessed by a user device in an ad-hoc manner such as, for example, home Wi-Fi, NFC (near field communication), Bluetooth, infrared radio frequency, in-car connectivity, and/or the like.

The user device 120 can be any type of electronic device configured to function as a client-side device of the system 100. Specifically, the user device 120 is configured to communicate with one or more server device(s) (e.g., the server device 140) via the network 150 to display AR content with AR target images for user(s) that operate the user device 120. In some embodiments, the user device 120 can be, for example, a cellular phone, a smart phone, a mobile Internet device (MID), a personal digital assistant (PDA), a tablet computer, an e-book reader, a laptop computer, a handheld computer, a desktop computer, a wearable device, and/or any other personal electronic device. In some embodiments, a user device can also be, for example, a mobile device, a client device, a terminal, a portable device, an AR device, and/or the like.

Additionally, a user operating the user device 120 can be any person (potentially) interested in viewing AR content and an AR target image in a single AR scene. Such a person can be, for example, an instructor, a photographer, a designer, a painter, an artist, a student, a computer graphics designer, etc. As shown and described herein, the system 100 (including the server device 140 and the user device 120) is configured to enable the user(s) operating the user device 120 to view AR content and an AR target image in the same AR scene.

Although shown as two separate devices in FIG. 1, in some embodiments, a single device can be configured to perform the functions of both the user device 120 and the server device 140. In such embodiments, for example, the single device (e.g., a smart phone with a large memory) can store a database of AR content. Thus, the single device can be configured to detect an AR target image, determine appropriate AR content by searching through the database of AR content, retrieve the appropriate AR content from the database of AR content, and then display the AR content with the AR target image. Furthermore, in some embodiments, a single device can have a client-portion configured to perform the functions of the user device 120, and a server-portion configured to perform the functions of the server device 140.

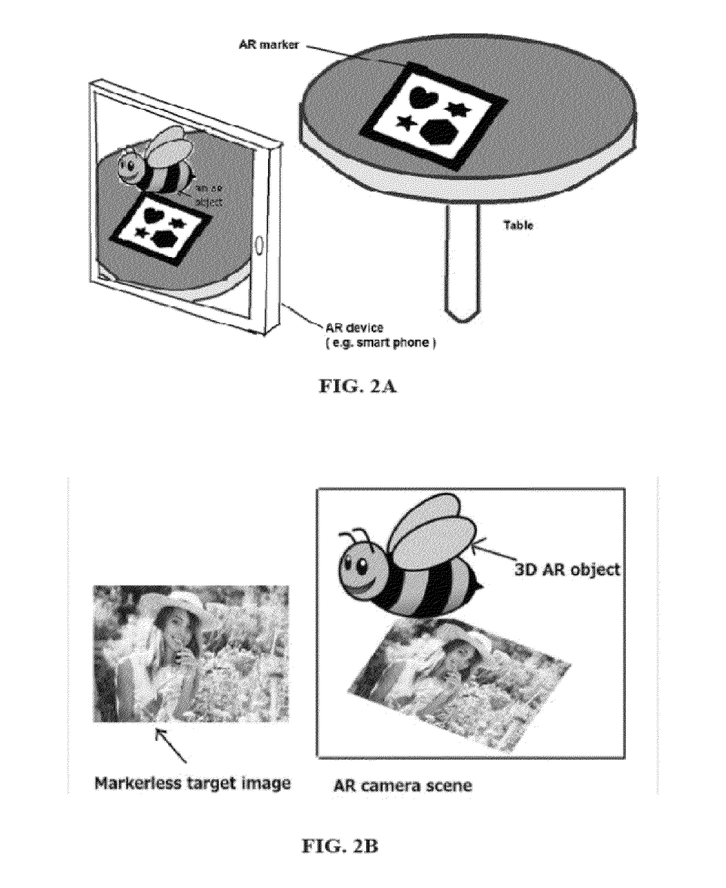

FIGS. 2A and 2B are schematic illustrations of displaying AR content together with an AR target image in a single AR scene in accordance with some embodiments. FIG. 2A illustrates a marker-based AR application configured to display AR content with an AR target image. The marker-based AR application can be stored and executed at an AR device (e.g., a smart phone as shown in FIG. 2A). As shown in FIG. 2A, the AR device detects an AR marker on the AR target image using, for example, a camera (e.g., a video camera, an image camera) of the AR device. An AR marker can be any type of marker, identifier, sign, symbol, etc. that can be used to uniquely determine appropriate AR content. In some embodiments, an AR marker can be, for example, a dot having predefined characteristics (e.g., shape, color, size, pattern, etc.). In some embodiments, an AR marker can be referred to as, for example, a fiducial marker.

The marker-based AR application identifies embedded AR index data based on the detected AR marker. The marker-based AR application then searches for appropriate AR content using the AR index data. AR content can include one or more any type of visible objects. In some embodiments, AR content can include a virtual object such as, for example, a 3D object (e.g., a 3D cartoon of bee as shown in FIG. 2A). If the marker-based AR application can retrieve appropriate AR content based on the AR index data, then the AR device displays the AR content (e.g., a 3D object such as the 3D cartoon of bee in FIG. 2A) together with the AR target image in the same AR scene. In some embodiments, as shown in FIG. 2A, the AR content can be displayed, for example, on the surface of the AR marker using an estimation of a 3D camera pose from the surface.

FIG. 2B illustrates a markerless AR application configured to display AR content with an AR target image. The markerless AR application can be stored and executed at an AR device. As shown in FIG. 2B, the AR device detects one or more visually distinctive features distributed in the AR target image as key points. Such a visually distinctive feature can be any feature in an image that can be visually distinguished from the remaining content of the image. A visually distinctive feature can be, for example, an angle, an area with a different color, a shape, a symbol, and/or the like. In some embodiments, a visually distinctive feature can be a part of the image, yet visually distinguished from the surrounding content of the image.

The markerless AR application then searches for appropriate AR content using the acquired key points. In some embodiments, for example, the markerless AR compares the acquired key points with reference key point data stored in a database, which are associated with various AR content. If the markerless AR application can retrieve appropriate AR content based on the acquired key points, then the AR device displays the AR content (e.g., a 3D object such as a 3D cartoon of bee in FIG. 2B) together with the AR target image in the same AR scene. In some embodiments, as shown in FIG. 2B, the AR content can be displayed, for example, on the surface of the visually distinctive feature(s) in the AR target image.

In some embodiments, a marker-based AR application typically requires relatively lower CPU burden than a markerless AR application as the detection algorithm for a fiducial marker is simpler than that of a markerless algorithm. However, the design of a marker usually provides non-esthetic visual look when it is applied to commercial products. On the other hand, the markerless AR application typically requires relatively high CPU burden, particularly for a continuous visual search from a database. A markerless algorithm may also show unreliable detection performance when the target image contains repetitive patterns and/or less-distinctive features, which are sometimes preferred by graphic design.

In some embodiments, a user device (e.g., an AR device, the user device 120 in FIG. 1) can use a hybrid method of a simplified-marker-based detection algorithm as a primary method and a markerless algorithm as a back-up method if the primary detection method fails to identify AR index data related to the AR content. In such embodiments, for example, the simplified marker can include a set of markers (e.g., five dots) that are located within a first region (e.g., a specified outer region) of a target image. The user device executes the primary method to detect the set of markers, and then to compute a set of cross ratios (e.g., two cross ratios) for the target image based on the set of markers.

After computing the set of cross ratios, the user device sends the computed set of cross ratios to a server device (e.g., the server device 140 in FIG. 1), which stores a database of a group of predefined (e.g., pre-computed) sets of cross ratios. Each set of cross ratios from the group of sets of cross ratios is uniquely associated with an AR content file from a group of AR content files. The server device determines, from the group of AR content files, an appropriate AR content file that is associated with the set of cross ratios received from the user device. The server device then retrieves and sends AR content of the AR content file to the user device, such that the user device displays the AR content with the target image in the same AR scene.

In some embodiments, occlusion and/or illumination on the set of markers (e.g., dots) may cause the user device to produce an incorrect calculation of cross ratio. As a result, execution of the primary method may not retrieve the appropriate AR content for the target image. In such embodiments, the markerless algorithm (i.e., the back-up method) can be activated to identify the appropriate AR content for the target image by detection of distinctive key points, similar to the process described above with respect to FIG. 2B. In some embodiments, a key point descriptor can be any type of data (uniquely) associated with a distinctive feature point on an AR target image. For example, a key point descriptor can be a specific vector form including a two-dimensional (2D) location of a distinctive feature point on a captured AR target image in the pixel coordinates.

In some embodiments, the distinctive key points (or distinctive features) of the target image can be located within a second region (e.g., a specified inner region) of the target image. In some embodiments, the second region and the first region can be mutually exclusive. In such embodiments, for example, a (complete) image is displayed within the second region; and the set of markers but no portion of the image is displayed within the first region.

In some embodiments, the hybrid method has one or more of the following features and advantages: 1) fast algorithm to retrieve AR index data using the cross ratio based AR content search; 2) reliable AR content search by the hybrid method of image processing; 3) low impact on the target image design in terms of esthetic visual look; and 4) low computational burden for both the AR device and the server device for identification of AR content.

In some embodiments, the software method associated with the hybrid method disclosed herein consists of simplified fiducial marker based AR algorithm as a primary identification method of AR index. The software method also executes markerless AR algorithm if the primary detection method fails to detect a specific set of markers. If the hybrid method computes the cross ratios of the set of markers (e.g., five dots) as a simplified marker set and/or distinctive key point descriptors, the AR device sends the computed cross ratios and/or the key point descriptors to the AR server for downloading the appropriate AR content. After the AR device successfully downloads the appropriate AR content from the AR server, the hybrid method computes a camera-pose matrix between the camera of the AR device in the 3D space and the surface of the target image, such that the AR device displays the AR content at an appropriate location with the target image in the same AR scene.

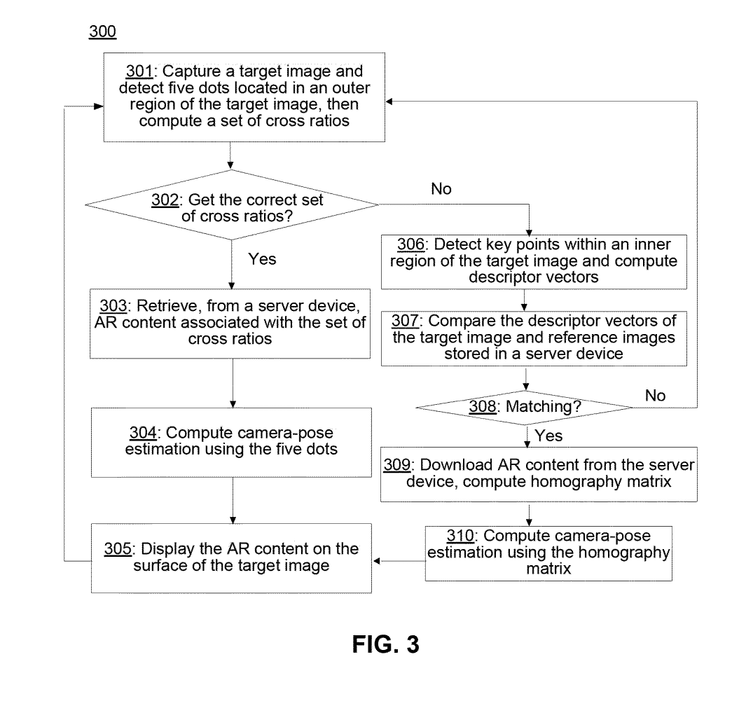

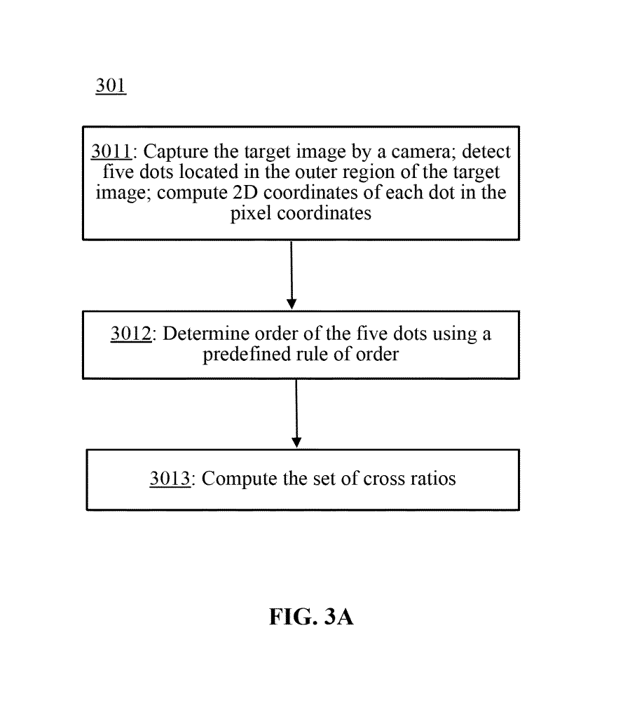

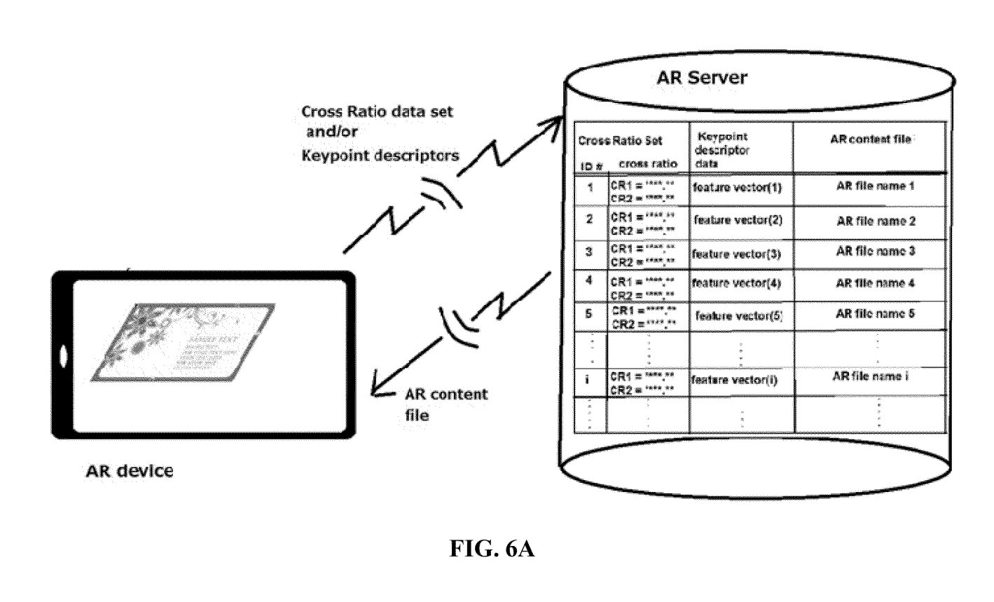

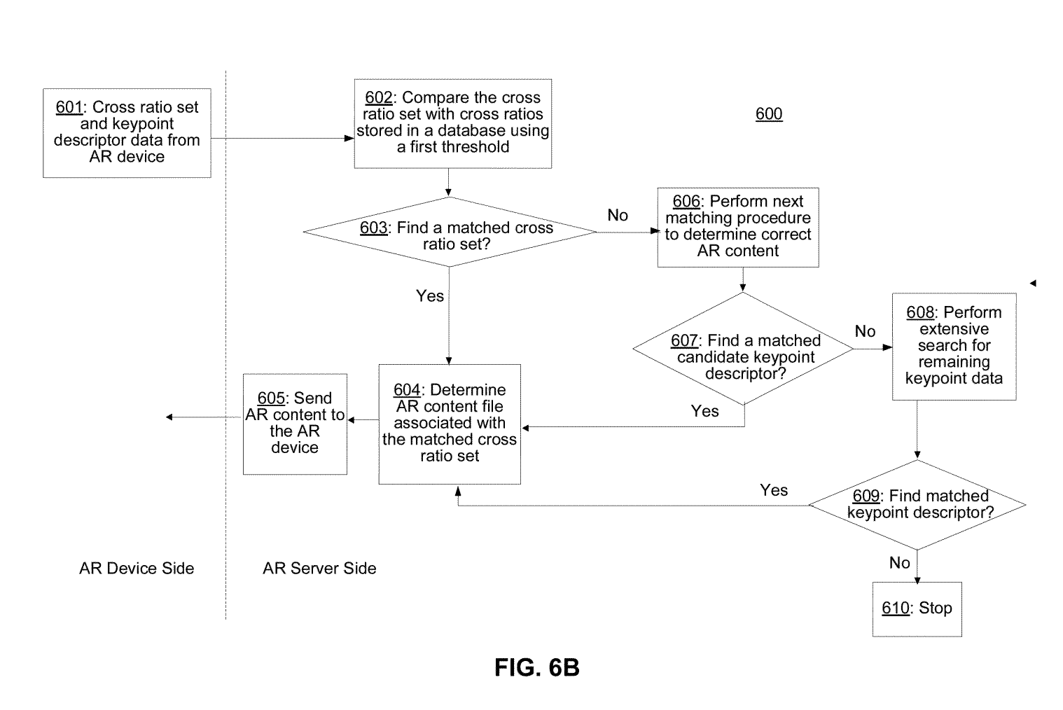

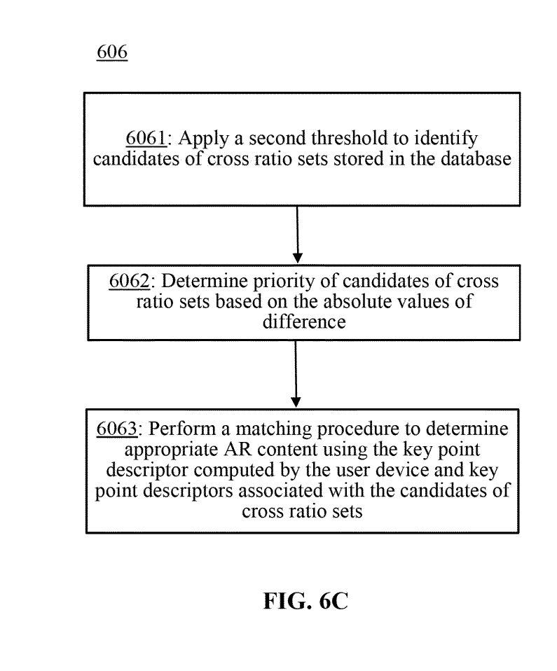

FIG. 3 is a flow chart illustrating a method 300 for retrieving and displaying AR content associated with an AR target image in accordance with some embodiments. The method 300 illustrates a process of performing the hybrid method described above. In some embodiments, the method 300 can be performed at a system consisting of a user device and a server device, which is structurally and functionally similar to the system 100 consisting of the user device 120 and the server device 140 shown and described above with respect to FIG. 1. Additionally, the user device and the server device can be operatively coupled to and communicate with each other via one or more networks (e.g., the network 150 in FIG. 1). FIGS. 6A and 6B illustrate computations at a server device and data communications between a user device and a server device in detail.

In some embodiments, the system (including the user device and the server device) performing the method 300 can include one or more processors and memory. In such embodiments, the method 300 can be implemented using instructions or code of an application that are stored in one or more non-transitory computer readable storage mediums of the system and executed by the one or more processors of the system. The application is associated with identifying an AR target image, determining appropriate AR content for the AR target image, retrieving and displaying the AR content, etc. In some embodiments, such an application can include a server-side portion that is stored in and/or executed at the server device, and a client-side portion that is stored in and/or executed at the user device. As a result of the application being executed, the method 300 is performed at the system. As shown in FIG. 3, the method 300 includes the following steps 301-310.

At 301, the user device captures a target image and detects five dots located in an outer region of the target image. The user device then computes a set of cross ratios. In some embodiments, the user device can receive data of a target image from, for example, an image-capturing device (e.g., a camera) of the user device. The user device can then detect, based on the data of the target image, a set of markers. In some embodiments, the set of markers can include more or less than five dots, and/or one or more other type of markers (e.g., identifiers, symbols, signs, etc. with various shapes, colors, sizes, patterns, etc.). In some embodiments, the target image can include two mutually-exclusive regions, where the set of markers (e.g., five dots) are located within one of the two regions, and an image is located with the other of the two regions. For example, the set of markers can be located within an outer region of the target image that surrounds an inner region of the target image. For another example, the set of markers can be located within a left region of the target image that is to the left of a right region of the target image.

FIG. 3A is a flow chart illustrating a method for performing the step 301 of the method 300 of FIG. 3. As described above, the step 301 can be performed at the user device of the system that performs the method 300. As shown in FIG. 3A, the step 301 includes the following sub-steps. At 3011, the user device captures the target image by a camera (e.g., a video camera, an image camera), detects five dots located in the outer region of the target image, and then computes 2D coordinates of each dot in the pixel coordinates. In some embodiments, the user device can detect the five dots based on the received data of the target image using any suitable image processing method such as, for example, binarization. Next, at 3012, the user device determines an order of the five dots using a predefined rule of order. Last, at 3013, the user device computes the set of cross ratios using the 2D coordinates of the five dots.

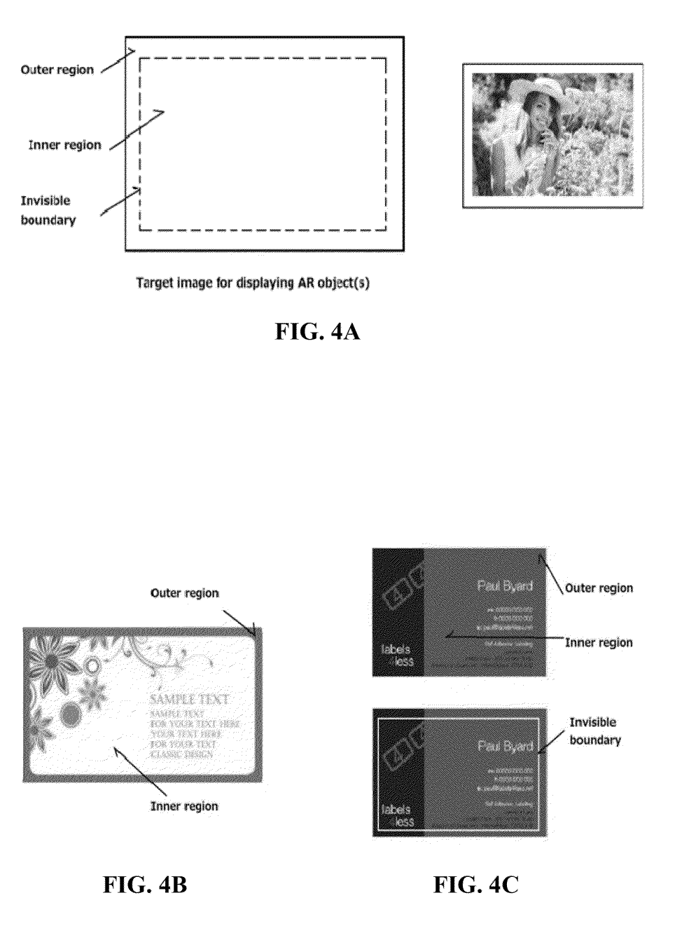

FIGS. 4A-4C are schematic diagrams illustrating layouts of AR target images in accordance with some embodiments. As an example, FIG. 4A depicts a basic layout of the surface of a target image in accordance with some embodiments. As shown in FIG. 4A, the target image consists of an outer region and an inner region, which are mutually exclusive with each other and can be separated by an optionally invisible boundary. An image can be displayed within the inner region, while no portion of the image is within the outer region. Similarly, a set of markers (e.g., five dots) can be displayed within the outer region, while no marker from the set of markers is displayed within the inner region.

As another example, FIGS. 4B and 4C depict custom-designed business cards as target images. As shown in FIGS. 4B and 4C, each custom-designed card is located within an inner region of a target image, and one or more markers are located within an outer region of the target image. Furthermore, the inner region and the outer region can be separated by a visible or invisible boundary. Additionally, in some embodiments, the image of the business card displayed in the inner region can extend to the outer region, as shown in FIG. 4C. In such embodiments, both the inner region and the outer region are used to display the image.

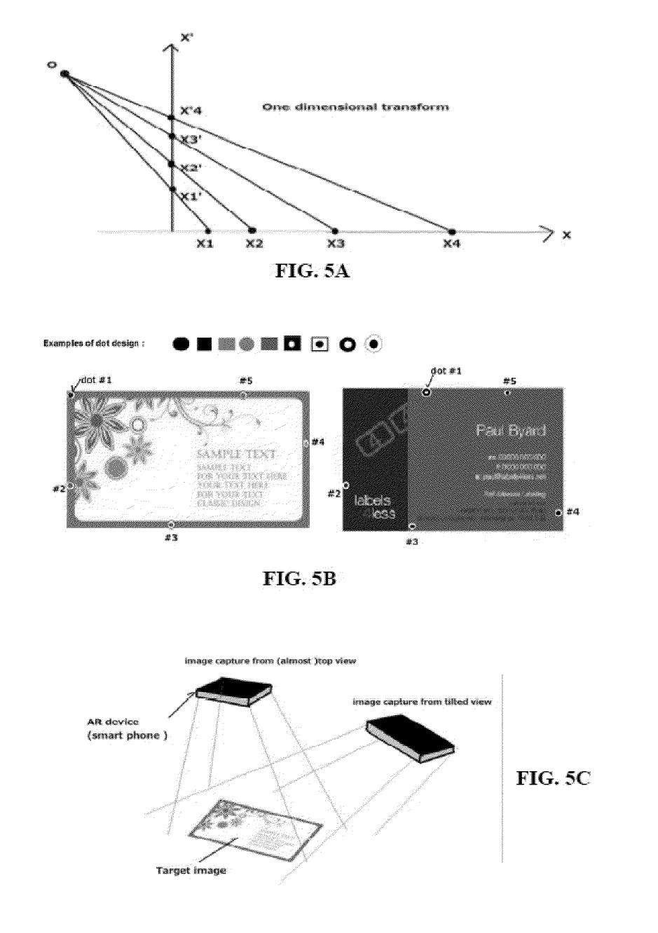

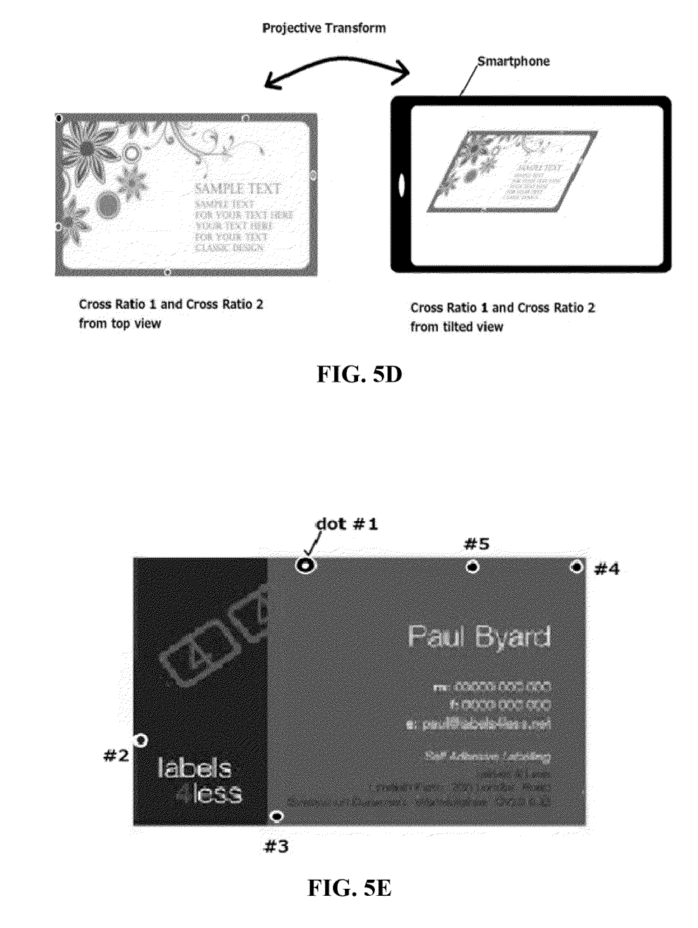

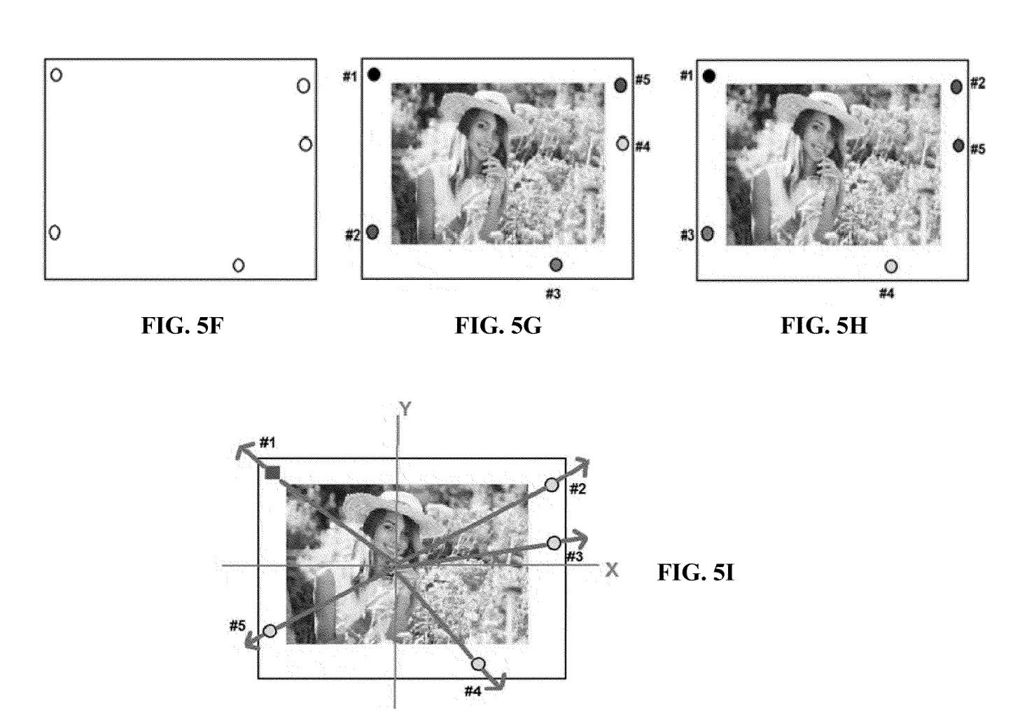

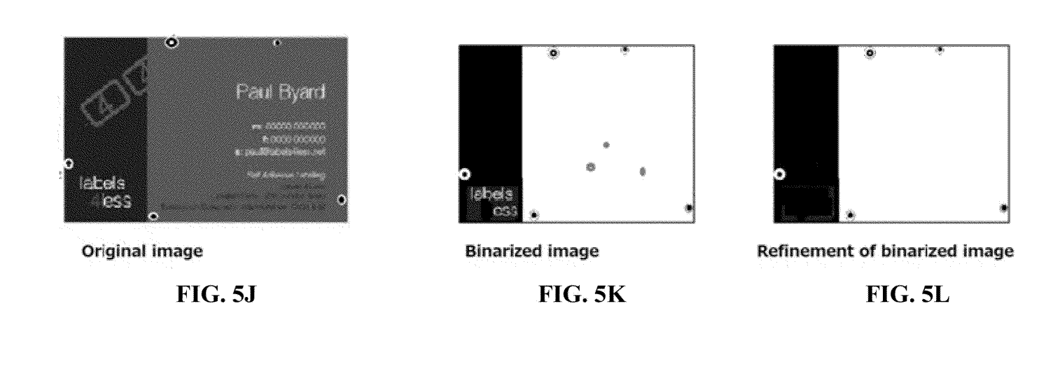

FIGS. 5A-5L are schematic illustrations of calculating cross ratios based on markers in an AR target image in accordance with some embodiments. In some embodiments, a cross ratio for a set of markers can be calculated using locations and an order of markers from the set of markers as inputs to an equation. For example, a cross ratio can be calculated based on a set of projected coordinates of the set of markers and a unique order of the set of markers, where the set of projected coordinates and the unique order of the set of markers can be determined from the received data of the AR target image. In some embodiments, a cross ratio can also be referred to as a double ratio.

In some embodiments, the cross ratio is defined as a ratio of ratio in the geometry fields of applied mathematics. For example, as shown in FIG. 5A, four lines extend from point O in one dimensional transform. Along these lines points X1, X2, X3, X4 and X1′, X2′, X3′, X4′ are related by a projective transform. As a result, their corresponding cross ratios, (X1, X2, X3, X4) and (X1′, X2′, X3′, X4′) are equal, as shown in Equation 1 below.

Cross Ratio=[(X1−X3)/(X2−X3)]/[(X1−X4)/(X2−X4)]=[(X1′−X3′)/(X2′−X3′)]/[(X1′−X4′)/(X2′−X4′)] Equation 1

In case of two-dimensional transform of geometry, the projective transform (also known as 2D homography transform) can preserve a cross ratio, the ratio of the ratio of lengths, collinearity of points and order of points across viewing. Since those projective invariants remain unchanged under the image transformation, the cross ratio can be used as an index to retrieve the appropriate AR content that is associated with the identical cross ratio corresponding to the specific target image. In other words, the cross ratio obtained from the captured target image in the pixel coordinates and the cross ratio computed from a reference image (e.g. a hard copy image as a “true image”) is identical. Thus, the cross ratio preserves a unique value of the target image from any viewing direction of the AR device that captures the target image.

For example, FIG. 5B illustrates two layouts of a target image, including five dots (dots #1 to #5 in FIG. 5B) as markers distributed in an outer region of the target image. Data of the five dots (e.g., a location such as projected coordinates of each dot, an order of the five dots, etc.) can be used to calculate cross ratios of the target image.

In some embodiments, the design of dots for the cross ratio calculation can be important in order to provide reliable recognition of the dots as markers for the target image. The layout of dots can have strong features in terms of, for example, shape, color, gray scale, size, etc. In some embodiments, for example, the shape of a small black dot with a white circle surrounding the small black dot (as shown in FIG. 5B) can be a design for reliable detection by image processing. Furthermore, in some embodiments, the dots can be located within an outer region of the target image (as shown in FIG. 5B) to make a clear separation from an arbitrary image drawn within an inner region of the target image.

In some embodiments, multiple cross ratios can be calculated for a set of multiple markers (e.g., five markers) with a given order. For example, as illustrated in Equations 2 and 3 below, at least two cross ratios can be calculated for a set of five markers (e.g., dots) with a given order.

Cross Ratio 1=(|M₄₃₁|×|M₅₂₁∥)/(|M₄₂₁|×|M₅₃₁|) Equation 2

Cross Ratio 2=(|M₄₂₁|×|M₅₃₂|)/(|M₄₃₂|×|M₅₂₁|) Equation 3

Where, each M^{ijk} is a matrix:

$${M}_{ijk} = ( \begin{matrix}Xi & Xj & Xk \\ Yi & Yj & Yk \\ 1 & 1 & 1\end{matrix} ) ,$$

with suffices i, j, and k being indexes of the markers in the given order (i.e., i, j, and k can be any of 1 to 5); (Xi, Yi) is the 2D coordinates of the marker with the index i; and the scalar value |Mᵢⱼₖ| is a determinant of matrix Mᵢⱼₖ. In some embodiments, a cross ratio for a set of markers can be calculated using any other suitable method.

FIGS. 5C and 5D illustrate a projective transform of a target image with its cross ratios being invariant. As shown in FIG. 5C, a user operates an AR device (e.g., a smart phone) to capture the target image from two different viewing directions: a (substantially) top view and a titled view. FIG. 5D illustrates the two different images captured from the two different viewing directions. As shown in FIG. 5D, the image captured from the titled view is deformed from the image captured from the top view like a parallelogram.

Next, projected coordinates (e.g., 2D coordinates) of each marker on the target image can be determined based on the captured images, and then cross ratios can be calculated, respectively, for the two captured images using the corresponding project coordinates. The resulted cross ratios for the two captured images, however, are identical because the cross ratio is a projective invariant. Specifically, the cross ratio calculated using Equation 2 for the captured image from the top view is equal to the cross ratio calculated using Equation 2 for the captured image from the titled view; and the cross ratio calculated using Equation 3 for the captured image from the top view is equal to the cross ratio calculated using Equation 3 for the captured image from the titled view.

In some embodiments, for example, one or more cross ratios for the captured image from the top view can be pre-calculated and stored in a database at an AR server as reference data. In such embodiments, an AR device can capture an image of the target image (e.g., a captured image from the titled view), calculate one or more cross ratios based on projected coordinates obtained from the captured image, and then send the calculated cross ratio(s) to the AR server. In response to receiving the calculated cross ratio(s), the AR server can compare the calculated cross ratio(s) with the pre-calculated cross ratios stored as reference data in the database to determine a match between the calculated cross ratio(s) and stored cross ratio(s). The AR server can then retrieve appropriate AR content associated with the matched cross ratio(s) and send the appropriate AR content to the AR device.

Similarly stated, in some embodiments, a user device can capture an AR target image from a first viewing direction, and calculate a first set of cross ratios based on a first set of projected coordinates of a set of markers of the target image that are associated with the first viewing direction. The user device can also capture the same AR target image from a second viewing direction different than the first viewing direction, and calculate a second set of cross ratios based on a second set of projected coordinates of the set of markers of the target image that are associated with the second viewing direction. The second set of projected coordinates is different from the first set of projected coordinates. Due to the invariant feature of cross ratios for the same target image, the first set of cross ratios is identical to the second set of cross ratios.

A calculation difficulty of the cross ratio is known in projective geometry of applied mathematics. In some embodiments, when three markers from a set of five markers are located on a same line (i.e., collinear), the cross ratios calculated for the set of five markers using Equations 2 or 3 will be zero or infinity. Therefore, in such embodiments, the distribution of the five markers should avoid such a collinear condition to obtain mathematically meaningful values for the cross ratios. FIG. SE depicts an example of the collinear condition described above, where dots #1, #4 and #5 are located (substantially) on the same line.

As described above, a cross ratio for a set of markers can be calculated based on an order of markers from the set of markers. In some embodiments, a cross ratio can have different values for different orderings of the same set of markers. In other words, a change in the order of the markers can cause a change in the resulted value of the cross ratio. In some embodiments, an order of a set of markers can be defined using any suitable method. For example, an order of a set of markers can be defined based on shapes of the markers, designs of the markers, colors of the markers, sizes of the markers, a predefined rotational direction, and/or the like.

FIGS. 5F-5H illustrate a cross ratio for a set of markers having different values based on different orderings of the set of markers. Specifically, FIG. 5F depicts a set of five dots distributed in an outer region of an AR target image. FIGS. 5G and 5H each depicts a set of five dots distributed in an AR target image in the same locations as those in FIG. 5F. That is, the dots at the same location in the three target images have the same projected coordinates (e.g., 2D coordinates) if the three target images are captured with the same viewing direction.

Furthermore, for example, an order of the five dots can be defined based on colors of the dots such that a black dot is marker number 1, a red dot is marker number 2, a green dot is marker number 3, a yellow dot is marker number 4, and a blue dot is marker number 5. As a result, if two dots at the same location in two of the three target images have different colors, then the orders of the five dots for the two target images are different. For example, based on the different pattern of colors between FIG. 5G and FIG. 5H, the orders of the five dots for the corresponding two target images are different, as shown in FIGS. 5G and 5H. Consequently, the calculated cross ratios for the two target images are different.

In some embodiments, as described above with respect to Equations 2 and 3, 2D coordinates (e.g., camera pixel coordinates) of each marker from a set of markers and the order of the set of markers are determined before cross ratios for the set of markers can be calculated. Various methods can be used to determine the order of the set of markers. For example, a marker having a different size, color, shape, etc. than the other markers from the set of markers can be determined as the first marker, and the order of the remaining markers can be determined based on a predefined rotational direction (e.g., clockwise or counter clockwise). For example, as shown in the target image on the right side of FIG. 5B, a dot having a white centroid inside a black circle is defined as dot #1 (while each other dot has a black centroid inside a white circle), and the remaining four dots are ordered using the counter clockwise direction rule.

FIG. 5I illustrates another method to determine the ordering of a set of markers. Specifically, a marker having a square shape can be defined as marker #1 (while each other marker has a round shape). Each marker can be identified in X-Y coordinates (e.g., pixel coordinates). The X-Y coordinates of each marker can be converted to cylindrical coordinates with a radius and an angle defined from the center of the pixel coordinates, as shown in FIG. 5I.

A pair of X-Y coordinates of a marker Pᵢ can be converted to cylindrical coordinates as: Pᵢ (Xᵢ,Yᵢ)=Pᵢ(r*cos θᵢ, r*sin θᵢ), where r=Square root of (Xᵢ̂2+Yᵢ̂2) is the radius, θᵢ is the angle, and Arctan(θᵢ)=Yᵢ/Xᵢ.

After the first marker is determined, the remaining markers can be ordered using their values of θ. For example, as shown in FIG. 5I, the order of the remaining four markers can be determined using the clockwise direction rule based on their values of θ.

FIGS. 5J-5L illustrate a method for detecting a set of markers using image processing of a target image. The original image captured by a camera of a user device is shown in FIG. 5J, which includes five dots in an outer region of the target image. This originally captured image can be modified to generate a binary image by a binarization process using a first threshold value. The output image of a first binarization is shown in FIG. 5K, which shows the five dots in the outer region. However, some image elements located in the inner region of the target image also remain in the binarized image of FIG. 5K as candidates of markers for cross ratio calculation. A second binarization with a second threshold value can be performed to eliminate undesirable image elements in the inner region. The refinement of binarized image is shown in FIG. 5L, which shows the five dots in the outer region and no image element in the inner region.

Returning to FIG. 3, after the set of cross ratios are calculated in 301, at 302, the user device determines whether the correct set of cross ratios is obtained. If the user device determines that the correct set of cross ratios is obtained, at 303, the user device retrieves, from the server device, AR content associated with the set of cross ratios. Subsequently, at 304, the user device computes a camera-pose estimation using the five dots. Finally, at 305, the user device displays the AR content on the surface of the target image.

Otherwise, if at 302 the user device determines that the correct set of cross ratios is not obtained, at 306, the user device detects key points within the inner region of the target image and computes descriptor vectors based on the detected key points. At 307, the server device compares the descriptor vectors of the target image and reference images stored in the server device. In some embodiments, the server device storing the descriptor vectors of reference images can be the same or a different server device with the server device that stores data of cross ratios in 303.

Subsequently, at 308, the server device determines whether the descriptor vectors of the target image match the descriptor vectors of any reference image. If the server device determines that the descriptor vectors of the target image do not match the descriptor vectors of any reference image, then the process is terminated for the target image and the process returns to and restarts from 301 for another target image.

Otherwise, if at 308 the server device determines that the descriptor vectors of the target image match the descriptor vectors of a reference image, at 309, the user device downloads appropriate AR content from the server device storing the descriptor vectors of the reference images. The user device then computes a homography matrix. Next, at 310, the user device computes a camera-pose estimation using the homography matrix. Finally, the user device proceeds to 305 to display the AR content on the surface of the target image.

FIG. 6A is a schematic diagram illustrating communications between an AR device (e.g., a user device) and an AR server (e.g., a server device) in accordance with some embodiments. The AR device in FIG. 6A can be structurally and functionally similar to the user device 120 shown and described with respect to FIG. 1. The AR server in FIG. 6A can be structurally and functionally similar to the server device 140 shown and described with respect to FIG. 1. In some embodiments, although not shown in FIG. 6A, the AR device and the AR server can be operatively connected via one or more networks similar to the network 150 shown and described above with respect to FIG. 1. In some embodiments, the AR device and the AR server can be connected via the Internet.

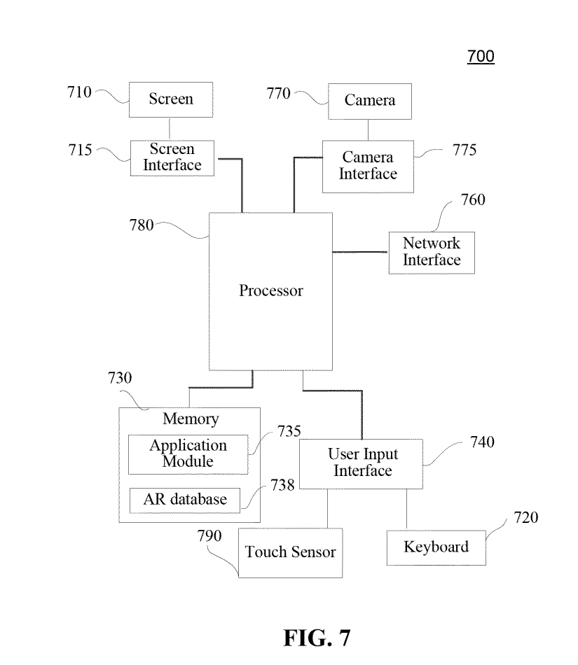

In some other embodiments, the AR device and the AR server can be operatively interconnected and reside within a single device. In yet some other embodiments, the AR device and the AR server can be operatively interconnected via a wireless network such as the IEEE 802.11 network standards, Bluetooth technologies, infrared radio frequency, NFC, or the like. In yet some other embodiments, the AR server can be a memory device configured to store the AR database, and the AR device can be connected to the AR server to access and retrieve AR content from the AR server. For example, the AR server can be a memory card configured to store the AR database, which can be inserted into the AR device's memory slot such that the AR device can retrieve AR content from the AR server. In some instances, the AR device can download the AR content from the AR server and store the downloaded AR content in the AR device's internal memory (e.g., AR database 738 in FIG. 7).

As shown in FIG. 6A, the AR server is configured to store a database including a table of multiple entries. Each entry in the table includes a unique ID number, a set of cross ratios (e.g., two cross ratios), data of a key point descriptor (e.g., a feature vector), and an identification of an AR content file. The set of cross ratios in each entry is a set of pre-computed cross ratios of a reference image associated with that entry. The feature vector in each entry contains pre-determined key point descriptors of a reference image associated with that entry. The AR content file in each entry contains predefined AR content associated with a reference image associated with that image.

In operation, the AR device sends to the AR server cross ratio data of a set of markers in a first region (e.g., an outer region) of a target image and/or key point descriptors of visually distinctive features in a second region (e.g., an inner region) of the target image. In response to receiving the cross ratio data and/or the key point descriptors, the AR server searches the database to determine matched cross ratio data and/or matched key point descriptors by comparing the received cross ratio data and/or key point descriptors with the cross ratios and feature vectors stored in the database. If the AR server determines a match, the AR server identifies an associated AR content file and retrieves AR content from the associated AR content file. The AR server then sends the retrieved AR content to the AR device, such that the AR device displays the AR content with the target image in the same AR scene.

FIG. 6B is a flow chart illustrating a method 600 for searching and retrieving AR content associated with an AR target image in accordance with some embodiments. The method 600 illustrates a process performed at the AR server (e.g., a server device) in FIG. 6A to search AR content from the database shown in FIG. 6A using cross ratio data and/or key point descriptor data received from the AR device (e.g., a user device) in FIG. 6A.

In some embodiments, the AR server can include one or more processors and memory. In such embodiments, the method 600 can be implemented using instructions or code of an application that are stored in one or more non-transitory computer readable storage mediums of the AR server and executed by the one or more processors of the AR server. The application is associated with determining and retrieving appropriate AR content for the AR target image. As a result of the application being executed, the method 600 is performed at the AR server. As shown in FIG. 6B, the method 600 includes the following steps 601-610.

At 601, the AR server receives a set of cross ratios and key point descriptor data from the AR device. As described above, the set of cross ratios can be calculated at the AR device based on a set of markers (e.g., five dots) located within a first region (e.g., an outer region) of the AR target image. The key point descriptor data can be computed at the AR device based on visually distinctive features located within a second region (e.g., an inner region) of the AR target image that is mutually exclusive from the first region.

At 602, the AR server compares the set of cross ratios with cross ratios stored in the database using a first threshold. At 603, the AR server determines whether the received set of cross ratios matches any stored set of cross ratios using the first threshold. Specifically, the AR server determines whether the received set of cross ratios is equal to any cross ratio data set stored in the database of the AR server. For example, such a comparison can be illustrated in the following Equation 4:

|Cross_Ratio(1)_dev−Cross_Ratio(1,j)_svr|<Threshold_{—}1

|Cross_Ratio(2)_dev−Cross_Ratio(2,j)_svr|<Threshold_{—}1

Where, Threshold_1 is the first threshold, which is a predefined threshold value for the first stage of evaluation; Cross_Ratio(1)_dev and Cross_Ratio(2)_dev are a pair of cross ratios computed by the AR device from the received data of the AR target image; and Cross_Ratio (1, j)_svr and Cross_Ratio (2, j)_svr are a pair of cross ratios with ID number j stored in the database of the AR server.

Thus, the AR server compares the received set of cross ratios (i.e., Cross_Ratio(1)_dev and Cross_Ratio(2)_dev) with each set of cross ratios (i.e., Cross_Ratio (1, j)_svr and Cross_Ratio (2, j)_svr) stored in the database to determine whether the received set of cross ratios and any stored set of cross ratios satisfy Equation 4.

If at 603 the AR server determines that the received set of cross ratios matches a stored set of cross ratios using the first threshold, then at 604, the AR server determines an AR content file that is associated with the matched cross ratio set. Subsequently, at 605, the AR server sends AR content of the determined AR content file to the AR device.

For example, if Equation 4 is satisfied by the stored set of cross ratios identified by ID number j, then the AR server determines that AR content associated with ID number j is appropriate for the AR target image. As a result, the AR server determines an AR content file associated with the ID number j in the database, then retrieves AR content from that AR content file and sends the AR content to the AR device. Consequently, the AR device displays the AR content with the AR target image in the same AR scene.

Otherwise, if at 603 the AR server determines that the received set of cross ratios does not match any stored set of cross ratios using the first threshold, at 606, the AR server performs a next matching procedure to determine appropriate AR content for the AR target image. Specifically, the AR server adopts another threshold (e.g., Threshold_2) to determine candidates of cross ratio sets that are close to the received set of cross ratios. Note that because the AR server fails the first stage of evaluation at 603, none of the candidates of cross ratio sets is equal to the received set of cross ratio according to the first threshold. In other words, none of the candidates of cross ratio sets satisfy Equation 4.

FIG. 6C is a flow chart illustrating a method for performing the step 606 of the method 600 of FIG. 6B. Specifically, FIG. 6C illustrates a matching procedure using another threshold value (e.g., Threshold_2) and key point descriptor data to determine appropriate AR content for the AR target image. As shown in FIG. 6C, the step 606 includes operations of 6061-6063 as follows.

At 6061, the AR server applies the second threshold to identify candidates of cross ratio sets stored in the database. Specifically, the AR server computes absolute values of difference between candidates of cross ratio sets and the set of cross ratios provided by the AR device. For example, a deviation (Diff) of each cross ratio set stored in the database from the received set of cross ratios can be calculated using the following Equation 5:

Diff(k)=|Cross_Ratio(1)_dev−Cross_Ratio(1,k)_svr|+|Cross_Ratio(2)_dev−Cross_Ratio(2,k)_svr|

Where Diff(k) is the absolute value of difference between a stored cross ratio set with ID number k and the set of cross ratios received from the AR device.

The AR server then compares the calculated deviation of each stored cross ratio set with the second threshold (e.g., Threshold_2), and identifies each stored cross ratio set whose deviation is less than the second threshold as a candidate cross ratio set. As a result, each identified candidate of cross ratio set is not equal but close to the set of cross ratios received from the AR device.

At 6062, the AR server determines priority of candidates of cross ratio sets based on the absolute value of difference (i.e., the deviation) of each candidate. Specifically, the AR server compares the deviation values of the candidates of cross ratio sets to place them in an order from the smallest to the largest. The first candidate has the smallest deviation and is the closest to the set of cross ratios received from the AR device among all the candidates. Similarly, the last candidate has the largest deviation and is the farthest to the set of cross ratios received from the AR device among all the candidates.

At 6063, the AR server performs a matching procedure to determine appropriate AR content using the key point descriptor data computed by the AR device and key point descriptors associated with the candidates of cross ratio sets, which are stored in the database of the AR server (as shown in FIG. 6A).

Specifically, according to the priority order determined at 6062, the AR server first compares the key point descriptor associated with the first candidate (i.e., the one having the smallest deviation) with the key point descriptor received from the AR device. If the key point descriptor associated with the first candidate matches (e.g., is equal to) the received key point descriptor, then the AR server determines that the first candidate is a matched candidate, and AR content of the AR content file associated with the first candidate is the appropriate AR content for the AR target image. Otherwise, if the key point descriptor associated with the first candidate does not match (e.g., is not equal to) the received key point descriptor, then the AR server subsequently compares the key point descriptor associated with the second candidate (i.e., the one having the second smallest deviation) with the key point descriptor received from the AR device.

Similarly, if the key point descriptor associated with the second candidate matches (e.g., is equal to) the received key point descriptor, then the AR server determines that the second candidate is a matched candidate, and AR content of the AR content file associated with the second candidate is the appropriate AR content for the AR target image. Otherwise, if the key point descriptor associated with the second candidate does not match (e.g., is not equal to) the received key point descriptor, then the AR server moves on to the third candidate. The AR server repeats such operations until a matched candidate is determined or all the candidates are compared to the data received from the AR device.

Returning to FIG. 6B, after the AR server performs the second matching procedure described above, at 607 the AR server determines whether the key point descriptor data received from the AR device matches any candidate key point descriptor (that is, a key point descriptor associated with a candidate cross ratio set). If the AR server determines that the key point descriptor data received from the AR device matches a candidate key point descriptor, the AR server proceeds to the steps 604-605 to retrieve and send AR content as described above.

Otherwise, if the AR server determines that the key point descriptor data received from the AR device does not match any candidate key point descriptor, at 608, the AR server performs extensive search for remaining non-candidate key point data that is not included in the search performed at 606-607. In other words, the AR server compares the received key point descriptor with the key point descriptors associated with each cross ratio set that is stored in the database and not identified as a candidate at 6061.

At 609, the AR server determines whether the key point descriptor data received from the AR device matches any remaining non-candidate key point descriptor. If the AR server determines that the key point descriptor data received from the AR device matches a remaining non-candidate key point descriptor, the AR server proceeds to the steps 604-605 to retrieve and send AR content as described above. Otherwise, if the AR server determines that the key point descriptor data received from the AR device does not match any remaining non-candidate key point descriptor, at 610, the process is terminated and no AR content is sent from the AR server to the AR device.

FIG. 7 is a block diagram illustrating components of a user device 700 in accordance with some embodiments. The user device 700 can be structurally and functionally similar to the user device 120 shown and described above with respect to FIG. 1 and the AR device shown in FIG. 6A. The user device 700 can be operatively coupled to (e.g., via one or more networks similar to the network 150 in FIG. 1) and communicate with one or more server devices (e.g., the server device 140 in FIG. 1, the AR server in FIG. 6A).

As shown in FIG. 7, the user device 700 includes a processor 780, a memory 730 (including an application module 735 and an AR database 738), a user input interface 740, a touch sensor 790, a keyboard 720, a network interface 760, a screen interface 715, a screen 710, a camera interface 775, and a camera 770. In some embodiments, the user device 700 can include more or less devices, components and/or modules than those shown in FIG. 7. One skilled in the art understands that the structure of the user device 1100 shown in FIG. 7 does not constitute a limitation for the user device 700, and may include more or less components than those illustrated in FIG. 7. Furthermore, the components of the user device 700 (shown or not shown in FIG. 7) can be combined and/or arranged in different ways other than that shown in FIG. 7. In some embodiments, the components and modules of the user device 700 can be configured to collectively perform the client portion of the methods described herein (e.g., the client portion of the method 300 shown and described above with respect to FIG. 3).

The network interface 760 is configured to enable of communications between the user device 700 and other devices (e.g., a server device) and/or networks. The network interface 760 is configured to send data to and receive data from another device and/or a network (e.g., the network 150 in FIG. 1). The network interface 760 is configured to send the received data to the processor 780 for further processing. In some embodiments, the network interface 760 can be configured to communicate with other network or device in a wireless and/or wired manner. In such embodiments, the network interface 760 can be configured to use any suitable wireless and/or wired communication protocol.

The user input interface 740 is configured to receive input data and signals and also generate signals caused by operations and manipulations of user input devices such as, for example, the touch sensor 790, the keyboard 720, and other user input means (e.g., a user's finger, a touch pen, a mouse, etc.). The screen 710 may be a touch screen (e.g., a liquid-crystal display (LCD), a light-emitting diode (LED), etc.) or a representation of a projection (e.g., providing projection signals). The screen 710 is commanded by the screen interface 715 that is controlled by the processor 780. The camera interface 775 is coupled to and controls the camera 770. The camera 770 can be any type of camera configured to capture an image such as, for example, a video camera, an image camera, a complementary metal-oxide semiconductor (CMOS) camera, etc.

The memory 730 is configured to store software programs and/or modules. The processor 780 can execute various applications and data processing functions included in the software programs and/or modules stored in the memory 730. The memory 730 includes, for example, a program storage area and a data storage area. The program storage area is configured to store, for example, an operating system and application programs such as the application module 735. The data storage area is configured to store data received and/or generated during the use of the user device 700 (e.g., AR content, data of target images, calculated cross ratios, etc.).

In some embodiments, as shown in FIG. 7, the data storage area of the memory 730 can include an AR database 738 that is similar to the AR database shown and described above with respect to FIG. 6A. Such an AR database can be, for example, downloaded or transmitted from a server device operatively coupled to the user device 700. In such embodiments, the user device 700 can retrieve AR content from the AR database 738 without downloading AR content from a server device externally connected to the user device 700.

The memory 730 can include one or more high-speed random-access memory (RAM), non-volatile memory such as a disk storage device and a flash memory device, and/or other volatile solid state memory devices. In some embodiments, the memory 730 also includes a memory controller configured to provide the processor 780 and other components with access to the memory 730. In some embodiments, the memory 730 may be loaded with one or more application modules that can be executed by the processor 780 with or without a user input via the user input interface 740.

In some embodiments, each application module included in the memory 730 can be a hardware-based module (e.g., a digital signal processor (DSP), an application-specific integrated circuit (ASIC), a field programmable gate array (FPGA), etc.), a software-based module (e.g., a module of computer code executed at a processor, a set of processor-readable instructions executed at a processor, etc.), or a combination of hardware and software modules. Instructions or code of each application module can be stored in the memory 730 and executed at the processor 780.

Specifically, for example, the application module 735 can be an AR application or module configured to perform a set of functions such as image processing for detecting AR target images, calculating cross ratios, displaying AR content in a camera view area in the screen 710, etc., which are described herein. Particularly, when such an AR application or module is executed, the user device 700 receives an image or video from the camera interface 775, and then processes the image or video to determine if a target image is captured or not. When such a target image is detected, the user device 700 further processes the image or video to overlay one or more AR objects on a real scene image or video. Thus, AR content and the target image are displayed in the same AR scene.

The processor 780 functions as a control center of the user device 700. The processor 780 is configured to operatively connect each component of the user device 700 using various interfaces and circuits. The processor 780 is configured to execute the various functions of the user device 700 and to perform data processing by operating and/or executing the software programs and/or modules stored in the memory 730 and using the data stored in the memory 730. In some embodiments, the processor 780 can include one or more processing cores.

Although shown and described above with respect to FIGS. 1, 3, 6A and 6B as two separate devices (e.g., a user device and a server device) performing the functions of retrieving and displaying AR content, in some embodiments, a single physical device can be configured to perform the functions of both a user device and a server device described herein. In such embodiments, the single physical device is configured to store an AR database. The single physical device is configured to capture a target image; calculate cross ratio data and/or key point descriptor data; use the calculated data to determine appropriate AR content from the AR database; retrieve the appropriate AR content; and display the retrieved AR content with the target image in the same AR scene.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

What is claimed is:

1. A method of detecting an augmented reality (AR) target image and retrieving AR content for the detected AR target image, comprising:
at a computer system having one or more processors and memory for storing programs to be executed by the one or more processors:
receiving data of the AR target image;
detecting, based on the data of the AR target image, a plurality of markers on the AR target image;
calculating a set of cross ratios based on locations of the plurality of markers;
retrieving, based on the set of cross ratios, AR content associated with the AR target image; and
displaying the retrieved AR content and the AR target image in a single AR scene.

2. The method of claim 1, wherein the plurality of markers are located within a first region of the AR target image, an image being displayed within a second region of the AR target image, the first region and the second region being mutually exclusive.

3. The method of claim 1, wherein the AR content includes a three-dimensional (3D) object.

4. The method of claim 1, wherein the plurality of markers includes at least five dots.

5. The method of claim 1, wherein the set of cross ratios includes at least two cross ratios.

6. The method of claim 1, wherein the calculating the set of cross ratios includes calculating the set of cross ratios based on a set of projected coordinates of the plurality of markers and a unique order of the plurality of markers, the set of projected coordinates and the unique order of the plurality of markers being determined based on the data of the AR target image.

7. The method of claim 1, wherein the calculating the set of cross ratios includes:
determining a unique order of the plurality of markers based on at least a shape of a marker from the plurality of markers, a design of a marker from the plurality of markers, a color of a maker from the plurality of markers, or a predefined rotational direction; and
calculating the set of cross ratios based on the unique order of the plurality of markers.

8. The method of claim 1, wherein the set of cross ratios is a first set of cross ratios of the AR target image, the receiving data of the AR target image including capturing the AR target image from a first viewing direction related to the AR target image, the calculating the first set of cross ratios including calculating the first set of cross ratios based on a first set of projected coordinates of the plurality of markers that are associated with the first viewing direction, the method further comprising:
capturing the AR target image from a second viewing direction related to the AR target image, the second viewing direction being different from the first viewing direction; and
calculating a second set of cross ratios based on a second set of projected coordinates of the plurality of markers that are associated with the second viewing direction and different from the first set of projected coordinates, the second set of cross ratios being identical to the first set of cross ratios.

9. The method of claim 1, wherein the retrieving AR content includes:
sending the calculated set of cross ratios to a database such that the calculated set of cross ratios is compared with a group of predefined sets of cross ratios stored in the database and a predefined set of cross ratios that matches the calculated set of cross ratios is determined from the group of predefined sets of cross ratios; and
retrieving, from the database, AR content associated with the determined predefined set of cross ratios.

10. A user device configured to detect an augmented reality (AR) target image and retrieve AR content for the detected AR target image, comprising:
one or more processors; and
memory storing one or more programs to be executed by the one or more processors, the one or more programs comprising instructions for:
receiving data of the AR target image;
detecting, based on the data of the AR target image, a plurality of markers on the AR target image;
calculating a set of cross ratios based on locations of the plurality of markers;
retrieving, from a database and based on the set of cross ratios, AR content associated with the AR target image; and
displaying the retrieved AR content and the AR target image in a single AR scene.

11. The user device of claim 10, wherein the calculating the set of cross ratios includes:
determining a unique order of the plurality of markers based on at least a shape of a marker from the plurality of markers, a design of a marker from the plurality of markers, a color of a maker from the plurality of markers, or a predefined rotational direction; and
calculating the set of cross ratios based on the unique order of the plurality of markers.

12. The user device of claim 10, wherein the plurality of markers are located within a first region of the AR target image, an image being displayed within a second region of the AR target image, the first region and the second region being mutually exclusive.

13. The user device of claim 10, wherein the plurality of markers includes at least five dots.

14. The user device of claim 10, wherein the set of cross ratios includes at least two cross ratios.

15. A non-transitory computer readable storage medium storing one or more programs, the one or more programs comprising instructions, which, when executed by one or more processors, cause the processors to perform operations comprising:
at a user device:
receiving data of the AR target image;
detecting, based on the data of the AR target image, a plurality of markers on the AR target image;
calculating a set of cross ratios based on locations of the plurality of markers;
retrieving, from a database and based on the set of cross ratios, AR content associated with the AR target image; and
displaying the retrieved AR content and the AR target image in a single AR scene.

16. A method of searching and retrieving augmented reality (AR) content for an AR target image, comprising:
at a computer system having one or more processors and memory for storing programs to be executed by the one or more processors:
receiving a set of cross ratios associated with the AR target image;
comparing the received set of cross ratios with a group of predefined sets of cross ratios, each predefined set of cross ratios from the group of predefined sets of cross ratios being associated with an AR content file from a group of AR content files;
determining, based on the comparison result, an AR content file from the group of AR content files;
sending AR content associated with the AR content file to a user device such that the user device displays the AR content and the AR target image in a single AR scene.

17. The method of claim 16, wherein the determining the AR content file includes:
determining, from the group of predefined sets of cross ratios, a predefined set of cross ratios that matches the received set of cross ratios; and
identifying, from the group of AR content files, the AR content file associated with the determined predefined set of cross ratios.

18. The method of claim 16, wherein each predefined set of cross ratios from the group of predefined sets of cross ratios being associated with data of a keypoint descriptor and an AR content file from a group of AR content files, the data of the keypoint descriptor being associated with the AR content file, the method further comprising receiving data of a keypoint descriptor of the AR target image, the determining the AR content file includes;
identifying, based on the comparison result and from the group of predefined sets of cross ratios, a subset of the group of predefined sets of cross ratios, each predefined set of cross ratios from the subset of the group of predefined sets of cross ratios being closer to the received set of cross ratios than each predefined set of cross ratios excluded from the subset of the group of predefined sets of cross ratios;
comparing the data of the keypoint descriptor of the AR target image with data of keypoint descriptors associated with the subset of the group of predefined sets of cross ratios;
determining, based on the comparison of data of keypoint descriptors, data of a keypoint descriptor that matches the data of the keypoint descriptor of the AR target image; and
identifying the AR content file associated with the determined data of keypoint descriptor.

19. A system comprising a user device and a server device, wherein:
the user device is configured to receive data of an augmented reality (AR) target image;
the user device configured to detect, based on the data of the AR target image, a plurality of markers on the AR target image;
the user device configured to calculate a set of cross ratios based on locations of the plurality of markers;
the user device configured to send the calculated set of cross ratios to the server device;
the server device configured to compare the set of cross ratios received from the user device with a group of predefined sets of cross ratios, each predefined set of cross ratios from the group of predefined sets of cross ratios being associated with an AR content file from a group of AR content files;
the server device configured to determine, based on the comparison result, an AR content file from the group of AR content files;
the server device configured to send AR content associated with the determined AR content file to the user device such that the user device displays the AR content and the AR target image in a single AR scene.

20. A method of detecting an augment reality (AR) target image and retrieving AR content for the detected AR target image using a computer system having one or more processors and memory for storing programs to be executed by the one or more processors, comprising:
receiving data of the AR target image;
detecting, based on the data of the AR target image, a plurality of markers on the AR target image;
calculating a set of cross ratios based on locations of the plurality of markers;
comparing the calculated set of cross ratios with a group of predefined sets of cross ratios;
if the calculated set of cross ratios matches a predefined set of cross ratios from the group of predefined sets of cross ratios,
retrieving AR content associated with the matching predefined set of cross ratios;
displaying the retrieved AR content and the AR target image in a single AR scene
if the calculated set of cross ratios does not match any predefined set of cross ratios from the group of predefined sets of cross ratios,
detecting, based on the data of the AR target image, a keypoint of the AR target image;
calculating a keypoint descriptor of the detected keypoint of the AR target image;
comparing the calculated keypoint descriptor with a group of predetermined keypoint descriptors;
if the calculated keypoint descriptor matches a predetermined keypoint descriptor from the group of predetermined keypoint descriptors,
retrieving AR content associated with the matching predetermined keypoint descriptor; and
displaying the retrieved AR content and the AR target image in a single AR scene.
